(19) United States
(12) Patent Application Publication
(10) Pub. No.: US 2018/0130049 A1
(43) Pub. Date: May 10, 2018

(54) CARD WITH INFORMATION FEATURES AND METHODS OF MAKING THE SAME

(71) Applicants: Jason Michael Busch, Van Nuys, CA (US); Keith George Ferry, Studio City, CA (US)

(72) Inventors: Jason Michael Busch, Van Nuys, CA (US); Keith George Ferry, Studio City, CA (US)

(21) Appl. No.: 15/346,601

(22) Filed: Nov. 8, 2016

(51) Int. Cl. G06Q 20/34; G06K 19/077; G07F 7/08

(52) U.S. Cl. CPC G06Q 20/3558; G07F 7/08; G06K 19/077

(57) ABSTRACT

Cards as disclosed are specially constructed to include machine readable information and include a substrate configured with one or more information features for use with an information readable device. The substrate may be selected by a user and be combined with one or more information features in a manner facilitating use of the card for an end-use application. The information features may be in a variety of forms including magnetic strip, chips, numeric information, alphabetic information, and combinations thereof. In an example, and information feature may be taken from an initial substrate and disposed into the selected substrate of the card to provide a customized card user experience. The user input and/or information feature(s) may be provided by conventional means, and the finished card may be sent to the user through the mail or the like once the card is made in accordance with the user's input and selection.

### FIELD

Cards as disclosed herein include one or more types of information capable of being read by a machine or the like, and are made to include one or more additional features according to an input provided by a card customer.

### BACKGROUND

Cards that include machine readable information such as credit cards or the like are known in the art, and are provided by the credit card issuer to a customer or card holder for use in making purchases. Such cards typically include the customer's name, an account number that may be embossed or otherwise provided in the card itself, which is made of plastic, and security information that may be provided in the form of a magnetic or other type of strip along a back portion of the card. Recently, credit card issuers have included another security feature in the form of a chip that is disposed within the card, and that may be read by machine of the like when the card is used to make point-of-purchase transaction. Other cards known in the art having machine readable information include cards such as those used at hotels to replace door keys, which may be used to open a room door by swiping or otherwise placing the card adjacent a card reader on the door that operates the door lock.

While such cards provided by card issuers are known in the art, there is a desire for card holders to have personalized cards not offered by card issuers that may have one or more custom features desired by such cardholder. It is, therefore, desired that such customized cards be provided in a manner addressing this need, and that a method for making such card be provided.

### SUMMARY

Card as disclosed herein are specially constructed to include machine readable information and comprise a substrate configured for use with an information readable device. The substrate may be selected from a number of different materials according to a user's preference. For example, the substrate may be formed from material selected from the group consisting of metals, metal alloys, plastics, composite materials, ceramic materials, paper, wood, and combinations thereof. The substrate is configured to comprising at least one information feature positioned at a location on the card to facilitate reading by the information readable device. In an example, the at least one information feature may be transplanted to the substrate from a different initial substrate. In an example, the at least one information feature may be provided in the form of a magnetic strip positioned along a surface of the card.

In an example where the information feature is provided from an initial substrate, and the information feature is in the form of a magnetic strip, the magnetic strip includes a portion of the initial substrate interposed between the magnetic strip and the card substrate. In such an example, e.g., where the information feature is provide from an initial substrate and in the form of a magnetic strip, such information feature is disposed within a recessed section of the substrate surface configured to accommodate placement of the magnetic strip therein. In such example, it is desired that the thickness of the card along the section including the magnetic strip enables readability by the information readable device in a normal manner.

In addition to or as an alternative to the magnetic strip, the information feature may be provided in the form of a chip positioned along a surface of the substrate. In such an example, the chip is disposed within a recessed section of the substrate surface. In an example where the chip was provided from an initial substrate, a portion of the initial substrate may be interposed between the chip and the substrate. In addition or as an alternative to the example information features noted above, the cards as disclosed herein may include further information, data or design selected from the group consisting of a person's name, numeric information, alpha-numeric information, graphic design, photographic design, colors, patterns, and combinations thereof depending on the user's preference and/or the particular card end use application.

Cards as disclosed herein may be made according to an example method for making such a card comprising machine readable information. An example of such method may include on that comprises receiving input from a user defining desired features of the card selected by the user. User input may be provided via a number of different avenues including mail delivery, electronically, by phone, or by any other manner conventional for providing information. The card is then prepared from a substrate selected by the user wherein the substrate is configured or conformed to include the desired features selected by the user. During such process one or more information features may be transferred to the substrate at a location on the substrate to facilitate readability by an information readable device or the like. Once the card is prepared it is then provided to the user by conventional means, which may be by mail delivery or the like.

In an example where the information feature or features are being provided from an initial substrate, the method includes receiving all or just the relevant portion of the initial substrate comprising such information feature(s). In such example, the one or more information features are removed from the existing card or initial substrate and are disposed onto a portion of the substrate at a desired location to facilitate readability of the prepared card by the information readable device. During such process of transferring the information features, the substrate may be prepared in a manner suited to facilitate placement and use of the information features. Such preparation of the substrate may include forming one or more recessed portions in a surface of the substrate, wherein the one or more recessed portions are configured to accommodate the respective one or more information features therein.

### BRIEF DESCRIPTION OF THE DRAWINGS

These and other features and advantages of cards and methods of making the same as disclosed herein will be appreciated as the same becomes better understood by reference to the following detailed description when considered in connection with the accompanying drawings wherein:

FIG. 1 illustrates a perspective view of an example card as disclosed herein;

FIG. 2 illustrates a top elevation view of the card of FIG. 1;

FIG. 3 illustrates a bottom elevation view of the card of FIG. 1;

FIG. 4 illustrates a sectional view of the card in FIG. 2; and

FIG. 5 illustrates a sectional view of the card in FIG. 3.

### DESCRIPTION

Cards as disclosed herein are made to include one or more types of information, e.g., security information, inventory information, user information, or any other type of information and/or data or the like, and generally comprise a substrate made from a desired material. Configured in such manner, the card substrate as disclosed herein may also be referred to as a shell before it has been configured to include the desired information or other data based on user desire or input. The substrate is configured to accommodate placement of the one or more types of information therein or thereon, may be made from a variety of different materials, may have additional information disposed therein, and may have one or a number of colors and/or graphics and/or designs. A feature of such cards is that they may be configured from the substrate for use in an intended purpose, e.g., as a credit card of the like, yet have information and/or features and/or design elements as selected by the user so as to provide the user a personalized experience when using the card.

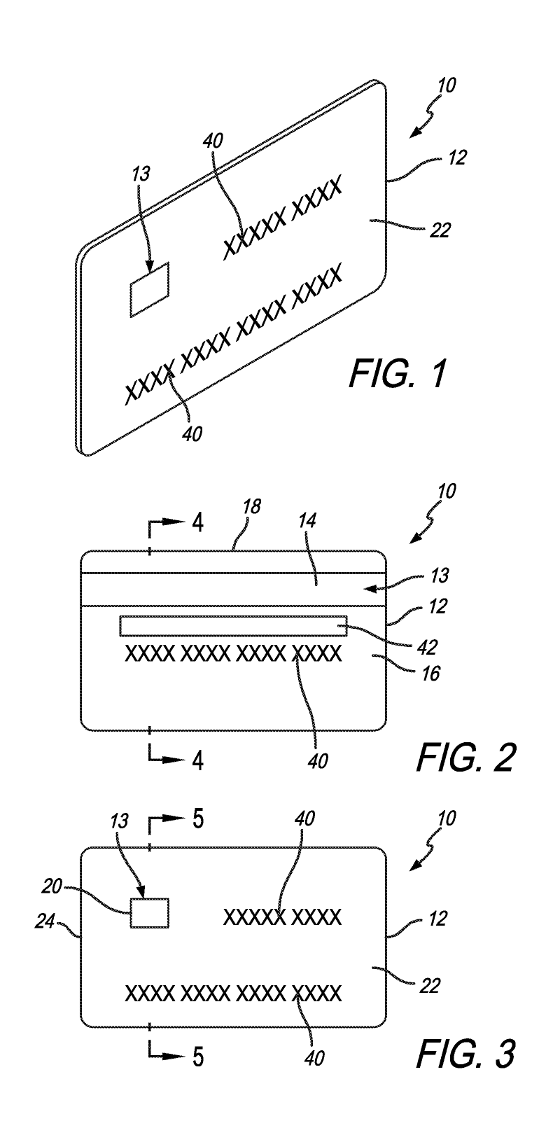

FIGS. 1 to 5 illustrate an example card 10 as disclosed herein that comprises a substrate or shell 12 configured into a desired shape. In an example, the substrate may be formed from any type of material having sufficient rigidity for purpose of being used for an intended purpose. In one example, the card may be used as a credit card, a hotel key or the like, and is formed from is formed material having sufficient rigidity to permit use with a card reader or the like for obtaining machine readable information therefrom.

Example materials useful for forming cards as disclosed herein include metals and metal alloys, plastic, composite materials such as carbon fiber and the like, ceramic materials, and other materials again that display a desired degree of rigidly to permit use of the card for an intended purpose. The material may also be selected on the basis of aesthetics in addition to rigidity, to provide a desired look or design to the user as well as function.

The substrate may have a shape that varies depending on the intended purpose. In an example, where the card 10 is to be used as a credit card, the substrate 12 may be configured having a rectangular shape similar to that of a credit card. While a rectangular shape has been described and illustrated, it is to be understood that cards as disclosed herein may have substrates configured having other than rectangular shapes and be within the scope of cards as disclosed herein.

A feature of cards 10 as disclosed herein is that they include one or more information features or elements 13, which may be provided in a number of different embodiments. When cards 10 as disclosed herein are used as a credit card, the information feature may be provided in the form of a magnetic strip 14 or the like that is provided in a configuration and on a position of the card to permit readability of the information feature so that the card may be used in an intended manner that is positioned. In an example where the card is used as a credit card, the information feature in the form of a magnetic strip 14 is positioned along a backside surface 16 of the card, running lengthwise adjacent a top edge 18, i.e., where such magnetic strips are normally positioned on credit cards issued by a credit card issuer. Configured in this matter, with the information feature provided in the form of a magnetic strip and positioned as noted above, the card as disclosed herein may function as a credit card and permit information on the magnetic strip to be taken or read by a machine, e.g., at a point of purchase or sale.

Other types of information feature embodiments aside from magnetic strips may include and are not limited to chips, RFID elements, and other members, elements or devices that can be carried in or on the substrate to convey information to a reader or other device configured for the same purpose.

In an example, the substrate 12 is formed from a material capable of accommodating the one or more of the information features. As illustrated, in an example, the substrate 12 may include an information feature 13 in the form of a chip 20 disposed on or in the substrate in a manner and at a location to permit the information from the chip to be conveyed during an intended use of the card. For example, where the card is intended to be used as a credit card, the chip 20 may be placed along a frontside surface 22 of the card adjacent a side edge 24.

Accordingly, while in the example card illustrated, the card includes information features of a magnetic strip 14 and a chip 20, it is to be understood that cards as disclosed herein may include one or any number of information features or elements that may be the same or different, and/or that may be positioned differently from that illustrated to suit the particular card intended end-use application.

The one or more information features may be combined with the substrate in a manner that will permit use of the information feature in a normal manner of using the card in the intended end-use application. In an example, where the information feature is a magnetic strip as disclosed above, the magnetic strip is combined with the substrate in a manner that permits readability of information from the magnetic strip using a conventional magnetic strip reader, such as those used to read credit card information at a point of purchase. It is, thus, desired that the thickness of the card along portion of where the magnetic strip is positioned be the same as that of a conventional card comprising a magnetic strip, again to permit readability using existing equipment already in place.

In an example, where the information feature is a chip as disclosed above, the chip is combined with the substrate in a manner that permits readability of information from the magnetic strip using a conventional chip reader, such as those used to read credit card information at a point of purchase. It is, thus, desired that the thickness of the card along portion of where the chip is positioned be the same as that of a conventional card comprising a chip, again to permit readability using existing equipment already in place.

In an example, the one or more information features present in cards 10 as disclosed herein may include those initially present in another card, such as a credit card issued by a card issuer. In such case, the information feature is removed from the initial or donor card and is then is combined with the card as disclosed herein. In an example where the information feature is a magnetic strip, the magnetic strip may be taken from the donor card by cutting the plastic donor card along the length of the donor card a desired margin away from the magnetic strip so as to not damage the magnetic strip. The remaining portion of the donor card may be discarded and the portion of the donor card containing the magnetic strip can be prepared for combination with the substrate of the card.

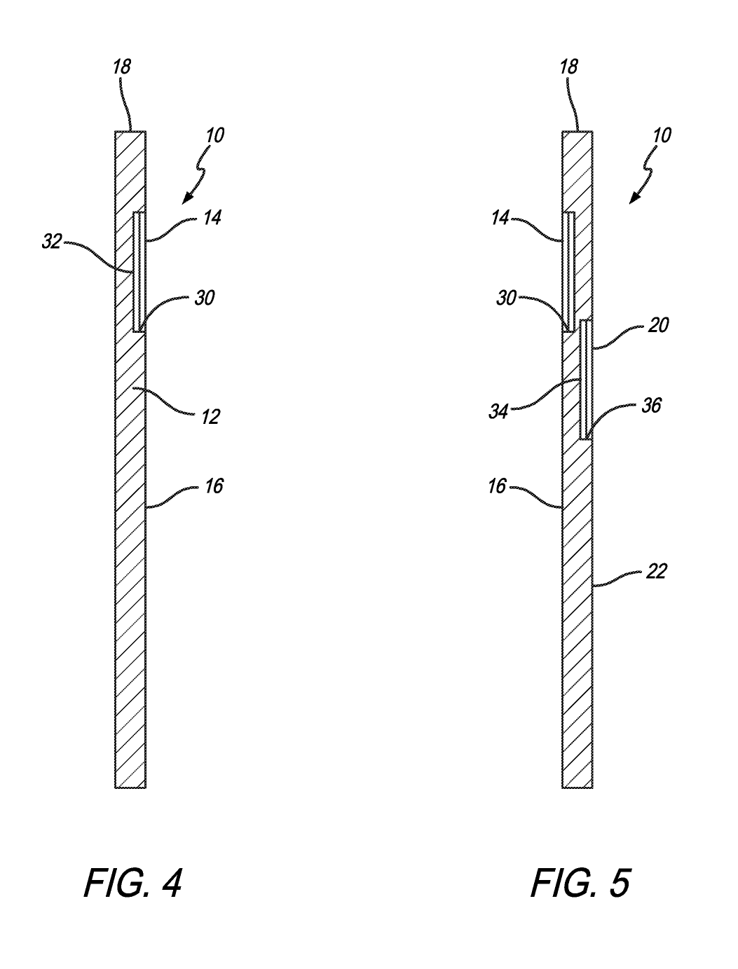

Referring to FIGS. 4 and 5, in an example, the substrate 12 may be configured having a channel 30 or recessed section running along the length of the card backside surface 16 where the magnetic strip 14 will be positioned. The channel in the substrate may be formed by mold or machine process depending on the particular material used to form the substrate. In an example, the donor card portion 32 attached to the magnetic strip 14 is reduced in thickness, e.g., by sanding, machining, etching, cutting or other process. In an example, the donor card portion thickness is reduced by about 25 percent to about 75 percent of its initial thickness. In an a particular example where the donor card is a credit card, the initial credit card thickness is approximately 0.813 mm, and the thickness of the donor card portion 32 attached with the magnetic strip 14 as readied for combining with the substrate 12 may be in the range of from about 0.050 mm to 0.750 mm, and preferably approximately 0.25 mm. Additionally, the margin of the donor card portion extending beyond the magnetic strip may be reduced for purposes of combining with the substrate 12.

In an example, the channel 30 has a depth as measured from the backside surface 16 that is both sufficient to accommodate placement of the donor card portion 32 and magnetic strip 14 therein and have an overall card thickness along the portion containing the magnetic strip that permits the magnetic strip as combined with the substrate 12 to be used with an existing information readable device, such as a credit card reader or the like. In an example, the depth of the channel can be from about 25 percent to 70 percent of the total thickness of the substrate. In a particular example, where the card will be used as a credit card and the donor card portion attached with the magnetic strip using double sided tape was a credit card, the depth of the channel 30 may be in the range of from about 0.100 mm to 0.750 mm, and preferably approximately 0.363 mm. The depth of the channel may also be such as to accommodate an adhesive, double-sided tape, or other suitable material and/or means for securing placement of the donor card portion within the channel and yet provide the final overall desired card thickness along the magnetic strip to facilitate reading of the same with existing information reading devices.

Referring to FIG. 5, in the event that cards as disclosed herein include an information feature in the form of a chip, such as that used with credit cards, such chip 20 may be removed from an initial donor card for combining with the substrate. As noted above for the magnetic strip taken from a donor card, the chip 20 may be removed in a similar manner, by cutting away a portion of the donor card attached with the chip leaving a desired margin of the donor card around the chip so as to ensure against damage to the chip during removal. The removed donor card portion 34 and chip 20 is then treated in the manner noted above to reduce the overall thickness of the donor card portion 34. The substrate 12 is configured having a recessed section 36 that is configured to accommodate placement of the donor card portion 34 and chip 20 therein. The recessed portion can be formed by molding, etching, machining, sanding, cutting or other method known in the art depending on the particular type of material selected for the substrate.

It is desired that prior to placement of the donor card portion 34 and chip 20 into the recessed section 36 that the margin of the donor card existing around the chip be reduced. As with the donor card portion and magnetic strip noted above, it is desired that the depth of the recessed portion 36 be sufficient to provide an overall card thickness along the portion containing the chip 20 so as to facilitate reading the same with existing information reading devices.

While particular examples of cards as disclosed herein have been described and illustrated as including information features taken from a donor card, it is to be understood that cards as disclosed herein may include information features that are new or otherwise not taken from a donor card. In such example, the information feature, e.g., in the form of a magnetic strip, a chip, or the like, may be combined with the substrate in a manner not involving a portion of the donor card, i.e., the magnetic strip or chip or the like may be attached to the relevant portion of the substrate in a manner facilitating readability of the information feature using conventional or existing information reading technology.

The substrate used to form cards as disclosed herein may be of any desired color, size, shape and configuration that enables functional use of the one or more information features while also providing the user with a personalized ownership experience. In an example, the user may select one or a number of different colors depending on the particular material selected for the substrate. In an example where the substrate is selected from a plastic material, the plastic may of any desired color. In an example where the substrate is selected from a composite material, the color or look of the substrate may be native to the material or may be colored. The same is true for substrates selected from a metal or metal alloy material. The substrate may include a variety of different patterns, ornamental or other types of designs, insignias, logos or the like that may be well known and/or existing, or that may be custom made by the user for use in making the card on one or both of the frontside and backside surface depending on the user's preference. Additionally, the substrate may have one or more holes disclosed therethrough that may be provided for functional use and/or ornamental design.

In addition to the one or more information features described above, cards as disclosed herein may include additional information 40 such as alphabetic information, like as the user's name or the like on a surface of the substrate, e.g., printed, etched, embossed or the like onto or into the substrate. The additional information 40 may also include numeric information, such as an account number, an expiration date, a security code, or the like on a surface of the substrate, e.g., printed, etched, embossed or the like onto or into the substrate. This information may be provided on a frontside and/or backside surface of the substrate depending on the user's preference. Additionally, cards as disclosed herein may include a feature or element 42 enabling placement of a user's signature thereon, such as is common with credit cards that may be placed on the frontside or backside surface of the substrate.

Cards as disclosed herein may be provided to a customer in a number of different manners that involve receiving input from the customer regarding the desired choice of substrate material, color, design and the like. Additionally, in the event that the information features are taken from a donor card, the user will provide all or a portion of the donor card comprising such one or more information features. In an example, when the desired card will be used as a credit card, the user may receive a new replacement credit card from the card issuer that will be used as a donor card for purposes of receiving the information features. If desired, before activating the new donor card, the user can send the card to a receiving point, which may be a manufacturing location for making the card, by mail. If desired, the user can cut the donor card in a manner such that it only includes the one or more information features to be transition to the substrate for purposes of not sending other information on the card such as the credit card account number and/or the cardholder name. In such method, the card is then made to include the desired features of the user and can be mailed back to the user with a given timeframe for use.

It is to be understood that there are many different ways in which the information use for making cards as disclosed herein may be conveyed from the user to the card maker for purposes of making the desired card as disclosed herein. For example, all information may be provided by mail to the card maker, and the prepared card may be sent back to the user by mail. Alternatively, the user may provide their order information can be provided electronically, e.g., via a website or other electronic communication means, to the maker of the card, the card is made and may be picked up by the user at the point of making or some other location, or may be mailed to the user.

In an example where the one or more information features are not taken from a donor card, but instead are new, the user input can be provided electronically, and the information features may be obtained electronically or by other means from a source of the information features for combining with the substrate used to make the card. In an example, the point of making and point of user input may be the same, e.g., in the form of a kiosk or the like, where the card can be made a short time after user input. Such manner of making the cards may depend having an inventory of certain selection of substrates on hand, and also the ability to obtain and transfer the one or more information features on site, which may or may not be from a donor card.

In some examples where the magnetic strips, chips or other forms of information features are stock items, all that may be needed to complete the card to have the information features associated with the user is to conform, program, or otherwise transfer the user information to such information features, which may already be combined with the substrate at the time of conforming, programming, transferring or the like. Thus, cards as disclosed herein may comprise substrates having a preformed construction wherein certain on or more information features are incorporated therein and ready for programming to identify with a certain user or anticipated end-use application.

If desired, cards as disclosed herein may be configured to include one or more additional features, such as a money clip, knife, light, and the like that may be useful to a user of the card. While certain examples of cards as disclosed have been described and illustrated for purposes of reference, it is to be understood that cards as disclosed herein may be configured differently than as disclosed and be within the scope and spirit of cards as disclosed. For example, while cards have been disclosed in the example content of credit cards, it is to be understood that cards as disclosed herein may be used for a variety of end-use applications were an information feature is associated, which examples may include but are not limited to hotel room keys, key cards and/or passes for certain restricted locations and/or events.

Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words ‘means for’ together with an associated function.

1. (canceled)

2. The card as recited in claim 21 wherein the at least one information feature is a magnetic strip positioned along a surface of the substrate.

3. The card as recited in claim 2 wherein the magnetic strip includes a portion of the existing card interposed between the magnetic strip and the substrate.

4. (canceled)

5. The card as recited in claim 3 wherein the thickness of the substrate with the magnetic strip along the section including the magnetic strip enables readability by the information readable device.

6. The card as recited in claim 21 wherein the at least one information feature is a chip positioned along a surface of the substrate.

7. The card as recited in claim 6 wherein the chip is disposed within a recessed section of the substrate.

8. The card as recited in claim 7 wherein a portion of the existing card is interposed between the chip and the substrate.

9. The card as recited in claim 21 wherein the substrate is made from a material selected from the group consisting of metal, metal alloys, plastics, composite materials, ceramic materials, paper, and the combinations thereof.

10. The card as recited in claim 21 further comprising the step of
including further information, data or design selected from the group consisting of a person's name, numeric information, alpha-numeric information, graphic design, photographic design, colors, patterns, and combinations thereof on the substrate.

11-20. (canceled)

21. A card including machine readable information, prepared by a process comprising the steps of
providing a substrate configured for use with one or more information readable devices and including one or more recessed portions in the substrate located for use with the one or more information readable devices;
providing one or more information features of an existing card;
positioning the one or more information features in the one or more recessed portions to facilitate readability by the one or more information readable devices.
